(19) United States
(12) Patent Application Publication
(10) Pub. No.: US 2004/0223040 A1
(43) Pub. Date: Nov. 11, 2004

(54) Polymeric microporous paper coating

(75) Inventors: Kristine M. Graham, Minnetonka, MN (US); Timothy H. Grafe, Edina, MN (US)

Correspondence Address: Merchant & Gould P.C., P.O. Box 2903, Minneapolis, MN, 55402-0903, US

(73) Assignee: Donaldson Company, Inc.

(21) Appl. No.: 10/832,533

(22) Filed: Apr. 26, 2004

Related U.S. Application Data
(63) Continuation-in-part of application No. PCT/US03/24411, filed on Aug. 5, 2003.
(60) Provisional application No. 60/404,113, filed on Aug. 15, 2002.

(51) Int. Cl. B41J 2/01; B41J 2/21

(52) U.S. Cl. 347/105

(57) ABSTRACT

The formation of a microporous layer or coating on sheet or paper stock using fine fiber can provide a writing surface that accepts ink, particularly ink jet ink, to obtain a crisp and sharp image. Such images can be alpha numeric or graphic images derived from printing, photography or produced from graphics software.

### RELATED APPLICATIONS

This application is a continuation-in-part application of PCT Application No. US03/24411 filed Aug. 5, 2003, which application claims priority under 35 U.S.C. § 119(e) to U.S. Provisional Application Serial No. 60/404,113 filed Aug. 15, 2002. The entire disclosure of U.S. Ser. No. 60/404,113 filed Aug. 15, 2002 is incorporated by reference.

### FIELD OF THE INVENTION

The invention relates to obtaining paper materials that can obtain clear alphanumeric characters and sharp graphic images for printing equipment. The invention relates to the formation of a printable, ink accepting and holding coating or layer on printable sheets, woven or non-woven stock such as paper stock. Such printable stock can have paper additives and coatings in conjunction with the printable layer or layers. The resulting stock can be used in printing, particularly ink jet and laser printing, lithographic and other printing processes to produce sharp alpha numeric characters and images that have sharp, detailed, well-defined borders between inked areas and at ink borders.

### BACKGROUND OF THE INVENTION

New printable substrate and paper structures are under development for use in current and newly developed printing equipment. This equipment includes commercial printers and printers used in conjunction with powerful desktop and laptop computers. Such printers are used to form alpha numeric and graphic images in black and white, and in color. Recent developments in printing technology have increased demands on printable bulk sheets and paper in both large scale lithographic etc. and small desktop printing equipment. Newer high-speed ink-jet and laser printing technology is used in conjunction with powerful imaging technology, in desktop and laptop computers in forming alpha-numeric and graphic images. A continuing effort has also been directed toward obtaining printable sheets and papers that can accept inks and toners of varying formulations. Such ink formulations include litho inks, powdered thermoplastic toners, high viscosity inks, low viscosity inks, felt tip pens, fountain pens, various size and composition of ball actuated pens and others. For any of these litho materials, toner and ink sources, the sheet or paper must readily accept the ink and maintain the ink where placed to maintain black or colored ink as a clear line or well defined image. Similarly, where a printer places ink on the page, the ink should also in such instances remain where the printer placed the ink, not diffuse laterally or horizontally through the paper, into other inked areas, or form a broken line through ink movement along the line segment. Further, due to the increased speed of available printers, even in relatively simple printing systems, many problems continue to exist for forming reliably either black and white or colored images.

Ink and toners are engineered to have dense effective black and white or coloring capability. During printing processes, ink or toner is applied to the surface of the paper using a variety of technologies. The ink desirably remains where placed, does not diffuse into adjacent inked or un-inked areas, dries quickly, and does not separate from the paper after application. When viewed at the surface of the paper, as the ink contacts the surface, the surface should be receptive to the presence of the ink, absorb the ink into its micro- and nanostructure to retain the ink in place as the ink is permitted to dry. Once dry, the ink is fixed in place and cannot migrate unless remoistened by a compatible solvent. Modern sheet stock and papers are relatively complex structures having a synthetic, cellulosic or mixed synthetic/cellulosic base that can be combined with both organic and inorganic coatings to provide a mat or gloss surface, a white appearance, a smooth appearance, and an ink accepting and maintaining surface. Accordingly, the ink accepting and maintaining properties of the paper, or more importantly, the paper coatings, must be compatible with the ink composition and absorb the ink in the intended location and maintain the ink until drying is an important feature.

In this invention, we are considering the use of papers having a layer or coating adapted for ink acceptance and positioning. In such organic and inorganic coated papers, the paper is made using a base or substrate that can contain other fibers or additives and coatings. A variety of coatings have been developed with this concept in mind. Such coatings have involved dispersions of small particulate inorganic materials, polymer coatings, silicate, glass fiber coatings and others. In this invention, the term “paper base or base layer” refers to a cellulosic web or cellulosic fiber web that acts as a writing paper substrate that has insufficient porosity or permeability to act as a filter media or a portion of a filtration unit. While filtration media and paper structures have some trivial similarity, paper for printing tends to be substantially thinner than and substantially less permeable than the thicker, less solid and more porous filter media webs.

Accordingly, a substantial need exists to develop a low cost sheet or paper structure that can permit high resolution printing at high speeds in both black and white and color, obtaining crisp, clear, alpha numeric characters and sharp graphic images.

### BRIEF DISCUSSION OF THE INVENTION

We have found that a distribution of a coating of fine fiber, preferably nanofiber, on a printable sheet stock or paper base provides a micro porous surface that is uniquely suited to accept and maintain black or colored inks. We have found that we can place a coating comprising about 1-50 layers, preferably 2 to 40 and most preferably 3 to 30 layers of fine fiber into an ink-accepting coating having an overall coating thickness of up to 100 microns, preferably about 5 to about 50 microns. Each individual layer can range from about 0.5 to about 10 microns.

We have found that the ink holding characteristic of the coating of the invention relates to the effective pore size of pores that are inherently formed as the fiber is deposited in a random fashion. The fine fiber coating formed on the surface of the paper tend to form in a nonwoven fiber layer(s) in which the fibers take a random position on the paper and inherently form pores where fibers interact with other fibers at different places in the nonwoven layer. We have found that the pore sizes, for excellent ink acceptance and retaining properties, should range from about 10 to about 3 microns, the porosity can also range from about 20 to about 500 nanometers (nM). Preferably, the pore size should range from about 25 to about 400 nM, most preferably 30 to 250 nM. We have further found that using hydrophilic or substantially hydrophilic polymers improve the ink acceptance and retention capacity of the fine fiber coating. We have further found that the polymers, which can have hydrophilic properties, can be improved by introducing further hydrophilic groups or additives into the fine fiber material to improve the hydrophilicity of the fiber or the fiber surface. We have found that the fine fiber material can be formed into a smooth uniform paper coating having surface characteristics not different than the inorganic, e.g., clay, coatings or the organic polymeric coatings made from soluble or insoluble fiber materials commonly available in papermaking. The resulting basis weight of the coating is about 1 10E-5 to 10E-3 gm-cm², preferably about 1.05E-5 to 5.25E-3 gm-cm².

Electrospinning polymer materials preferably form such layers. The electrospinning processes are commonly obtained by forming a solution of the polymer plus hydrophilic additives in an acceptable solvent. The polymer solution is then exposed to the effects of a strong electrical potential that causes the polymer solution to be spun into long, thin filaments which dry to form fibers having a diameter in the nano scale. Preferred fibers in this invention have a diameter that ranges from about 0.05 to about 2 microns, preferably about 0.1 to about 1 micron. For the purpose of this invention, the term “character” typically refers to an alphanumeric number or letter in either color or black and white format. The term “image” typically refers to the formation on paper of the representation of a three-dimensional object in two dimensions using either black and white or color reproduction. The microporous nature of the surface provides a location for the acceptance of ink compatible with ink compositions that can maintain the ink in a specific location until the ink dries to a sharp well-defined character or image. The fine fiber comprises typically a polymeric material that can be selected for ink compatibility. The resulting surface is both readily ink accepting and prevents migration of the inks from its intended location until drying.

### DETAILED DISCUSSION OF THE INVENTION

The printable layer or coating of the invention formed on a sheet stock or paper stock, comprises a spun fine fiber material having a defined fiber size, layer thickness, layer structure, and microporous character that can accept and retain inks as described. The stock can have a coating comprising 1-50 layers of the fine fiber material. The stock can comprise typically a synthetic, cellulosic, or mixed base combined with other fiber, other additives, organic and inorganic coatings, and other common web or paper technology. The fine fiber is typically spun onto the surface of the stock to form a final ink-accepting coating on one or both layers of the stock.

Printable substrates include paper, paperboard, metal, metal foils, plastic, plastic films, wovens or non-wovens and other material that can accept and retain a printed flexographic image. The primary focus of the invention is on printed-paper, paperboard or flexible non-woven and film materials. Paper and paperboard are sheet materials made of discrete cellulosic fibers that are typically bonded into a continuous web. Cellulosic fibers derived from a variety of natural sources including wood, straw, hemp, cotton, linen, manila, etc. can be used in papermaking. Cellulose is typically a polymer comprising glucose units having a chain length of 500 to 5000. Paper is made by typically pulping a fiber source into an aqueous dispersion of cellulosic fibers. The pulp, typically in a Fourdrinier machine, forms a wet cellulosic layer on a screen that is then pressed, dewatered and dried into a paper or paperboard composition. Typically, paper structures have a thickness less than 305 μm while paperboard; a thicker material typically has a thickness that exceeds 300 μm (250 μm in the United Kingdom). Paper normally weights 30-150 g/m², but special applications require weights as low as 16 g/m² or as high as 325 g/m². At any given basis weight (gramage), paper density may typically vary from 2.2-4.4 g/cm³, providing a very wide range of thicknesses. Paperboard typically is a material having a weight greater than about 250 g/m² of sheet material according to ISO standards. Commonly, paperboards are coated with a variety of materials to improve appearance, processability, printing capacity, strength, gloss or other material. Coatings are typically applied from aqueous or organic solution or dispersion. Coatings can often comprise pigments or other inorganic layers with binder materials which are typically natural or synthetic organic materials. Typical pigments include clay, calcium carbonate, titanium dioxide, barium sulfate, talcum, etc. Common binders include naturally occurring binders such as starch, casein and soya proteins along with synthetic binders including styrene butadiene copolymers, acrylic polymers, polyvinyl alcohol polymers, vinyl acetate materials and other synthetic resins.

One common structure used in or lithographic processes includes a paper or paperboard substrate, a clay layer (or other inorganic printable surface), a layer formed on and in the clay layer comprising ink or fountain solution with an acrylic overcoat layer providing protection for the ink and a glossy character if desired. Other layers can be used to improve or provide other properties or functions.

Lithographic printing processes are commonly used to provide an image on a metal object or foil or on a thermoplastic object (woven or non-woven) or film. Metal foils and thermoplastic films are commonly available in the marketplace and typically have a thickness of about 5.1 μm to 127 μm, preferably 12.7 to 76 μm. Common synthetic materials including aluminum foils, polyethylene films, cellulosic acetate films, polyvinyl chloride films, TYVEC® nonwovens and other materials.

A large variety of resin materials can be used in the synthetic substrate materials of the invention. For the purpose of this application, a resin is a general term covering either a thermoset or a thermoplastic. We have found that resin materials useful in the invention include both condensation polymeric materials and addition or vinyl polymeric materials and polymeric alloys thereof. Vinyl polymers are typically manufactured by the polymerization of monomers having an ethylenically unsaturated olefinic group. Condensation polymer resins are typically prepared by a condensation polymerization reaction which is typically considered to be a stepwise chemical reaction in which two or more molecules combined, often but not necessarily accompanied by the separation of water or some other simple, typically volatile substance. Such polymers can be formed in a process called polycondensation.

Polyolefin resins include polyethylene, polypropylene, polybutylene, etc. Vinyl resins include acrylonitrile-butadiene-styrene (ABS), polybutylene resins, polyacetyl resins, polyacrylic resins, homopolymers or copolymers comprising vinyl chloride, vinylidene chloride, fluorocarbon resins, etc. Condensation polymers include nylon, phenoxy resins, polyarylether such as polyphenylether, polyphenylsulfide materials; polycarbonate materials, chlorinated polyether resins, polyethersulfone resins, polyphenylene oxide resins, polysulfone resins, polyimide resins, thermoplastic urethane elastomers and many other resin materials.

Condensation polymer resins that can be used in the materials of the invention include polyamides, polyamide-imide polymers, polyarylsulfones, polycarbonate, polybutylene terephthalate, polybutylene naphthalate, polyetherimides, polyethersulfones, polyethylene terephthalate, thermoplastic polyimides, polyphenylene ether blends, polyphenylene sulfide, polysulfones, thermoplastic polyurethanes and others. Preferred condensation engineering resins include polycarbonate materials, polyphenyleneoxide materials, and polyester materials including polyethylene terephthalate, polybutylene terephthalate, polyethylene naphthalate and polybutylene naphthalate materials.

Polycarbonate engineering resins are high performance, amorphous engineering thermoplastics having high impact strength, clarity, heat resistance and dimensional stability. Polycarbonates are generally classified as a polyester or carbonic acid with organic hydroxy compounds. The most common polycarbonates are based on phenol A as a hydroxy compound copolymerized with carbonic acid. Materials are often made by the reaction of a bisphenol A with phosgene (O═CCl₂). Polycarbonates can be made with phthalate monomers introduced into the polymerization extruder to improve properties such as heat resistance, further trifunctional materials can also be used to increase melt strength or extrusion blow molded materials. Polycarbonates can often be used as a versatile blending material as a component with other commercial polymers in the manufacture of alloys. Polycarbonates can be combined with polyethylene terephthalate acrylonitrile-butadiene-styrene resins, styrene maleic anhydride resins and others. Preferred alloys comprise a styrene copolymer and a polycarbonate. Preferred melt for the polycarbonate materials should be indices between 0.5 and 7, preferably between 1 and 5 gms/10 min.

A variety of polyester condensation polymer materials including polyethylene terephthalate, polybutylene terephthalate, polyethylene naphthalate, polybutylene naphthalate, etc. can be useful in the composites of the invention. Polyethylene terephthalate and polybutylene terephthalate are high performance condensation polymer materials. Such polymers often made by a copolymerization between a diol (ethylene glycol, 1,4-butane diol) with dimethyl terephthalate. In the polymerization of the material, the polymerization mixture is heated to high temperature resulting in the transesterification reaction releasing methanol and resulting in the formation of the engineering plastic. Similarly, polyethylene naphthalate and polybutylene naphthalate materials can be made by copolymerizing as above using as an acid source, a naphthalene dicarboxylic acid. The naphthalate thermoplastics have a higher Tg and higher stability at high temperature compared to the terephthalate materials. However, all these polyester materials are useful in the composite materials of the invention. Such materials have a preferred molecular weight characterized by melt flow properties. Useful polyester materials have a viscosity at 265° C. of about 500-2000 cP, preferably about 800-1300 cP.

Polyphenylene oxide materials are engineering thermoplastics that are useful at temperature ranges as high as 330° C. Polyphenylene oxide has excellent mechanical properties, dimensional stability, and dielectric characteristics. Commonly, phenylene oxides are manufactured and sold as polymer alloys or blends when combined with other polymers or fiber. Polyphenylene oxide typically comprises a homopolymer of 2,6-dimethyl-1-phenol. The polymer commonly known as poly(oxy-(2,6-dimethyl-1,4-phenylene)). Polyphenylene is often used as an alloy or blend with a polyamide, typically nylon 6-6, alloys with polystyrene or high impact styrene and others. A preferred melt index (ASTM 1238) for the polyphenylene oxide material useful in the invention typically ranges from about 1 to 20, preferably about 5 to 10 gm/10 min. The melt viscosity is about 1000 at 265° C.

Another class of thermoplastic include styrenic copolymers. The term styrenic copolymer indicates that styrene is copolymerized with a second vinyl monomer resulting in a vinyl polymer. Such materials contain at least a 5 mol-% styrene and the balance being 1 or more other vinyl monomers. An important class of these materials is styrene acrylonitrile (SAN) polymers. SAN polymers are random amorphous linear copolymers produced by copolymerizing styrene acrylonitrile and optionally other monomers. Emulsion, suspension and continuous mass polymerization techniques have been used. SAN copolymers possess transparency, excellent thermal properties, good chemical resistance and hardness. These polymers are also characterized by their rigidity, dimensional stability and load bearing capability. Olefin modified SAN's (OSA polymer materials) and acrylic styrene acrylonitriles (ASA polymer materials) are known. These materials are somewhat softer than unmodified SAN's and are ductile, opaque, two phased terpolymers that have surprisingly improved weatherability.

ASA resins are random amorphous terpolymers produced either by mass copolymerization or by graft copolymerization. In mass copolymerization, an acrylic monomer styrene and acrylonitrile are combined to form a heteric terpolymer. In an alternative preparation technique, styrene acrylonitrile oligomers and monomers can be grafted to an acrylic elastomer backbone. Such materials are characterized as outdoor weatherable and UV resistant products that provide excellent accommodation of color stability property retention and property stability with exterior exposure. These materials can also be blended or alloyed with a variety of other polymers including polyvinyl chloride, polycarbonate, polymethyl methacrylate and others. An important class of styrene copolymers includes the acrylonitrile-butadiene-styrene monomers. These resins are very versatile family of engineering thermoplastics produced by copolymerizing the three monomers. Each monomer provides an important property to the final terpolymer material. The final material has excellent heat resistance, chemical resistance and surface hardness combined with processability, rigidity and strength. The polymers are also tough and impact resistant. The styrene copolymer family of resins has a melt index that ranges from about 0.5 to 25, preferably about 0.5 to 20.

An important class of engineering resins that can be used in the composites of the invention include acrylics. Acrylics comprise a broad array of polymers and copolymers in which the major monomeric constituents are an ester acrylate or methacrylate. These resins are often provided in the form of hard, clear sheet or pellets. Acrylic monomers polymerized by free radical processes initiated by typically peroxides, azo compounds or radiant energy. Commercial polymer formulations are often provided in which a variety of additives are modifiers used during the polymerization provide a specific set of properties for certain applications. Pellets made for resin grade applications are typically made either in bulk (continuous solution polymerization), followed by extrusion and pelleting or continuously by polymerization in an extruder in which unconverted monomer is removed under reduced pressure and recovered for recycling. Acrylic plastics are commonly made by using methyl acrylate, methyl methacrylate, higher alkyl acrylate and other copolymerizable vinyl monomers. Preferred acrylic resin materials useful in the composites of the invention has a melt index of about 0.5 to 50, preferably about 1 to 30 gm/10 min.

Vinyl polymer resins include a acrylonitrile; polymer of alpha-olefins such as ethylene, propylene, etc.; chlorinated monomers such as vinyl chloride, vinylidene dichloride, acrylate monomers such as acrylic acid, methylacrylate, methylmethacrylate, acrylamide, hydroxyethyl acrylate, and others; styrenic monomers such as styrene, alphamethyl styrene, vinyl toluene, etc.; vinyl acetate; and other commonly available ethylenically unsaturated monomer compositions.

Polymer blends or polymer alloys can be useful in manufacturing the pellet or linear extrudate of the invention. Such alloys typically comprise two miscible polymers blended to form a uniform composition. Scientific and commercial progress in the area of polymer blends has lead to the realization that important physical property improvements can be made not by developing new polymer material but by forming miscible polymer blends or alloys. A polymer alloy at equilibrium comprises a mixture of two amorphous polymers existing as a single phase of intimately mixed segments of the two macro molecular components. Miscible amorphous polymers form glasses upon sufficient cooling and a homogeneous or miscible polymer blend exhibits a single, composition dependent glass transition temperature (Tg). Immiscible or non-alloyed blend of polymers typically displays two or more glass transition temperatures associated with immiscible polymer phases. In the simplest cases, the properties of polymer alloys reflect a composition weighted-average of properties possessed by the components. In general, however, the property dependence on composition varies in a complex way with a particular property, the nature of the components (glassy, rubbery or semi-crystalline), the thermodynamic state of the blend, and its mechanical state whether molecules and phases are oriented.

The preferred paper base used in the invention typically comprises a web or sheet made from a cellulosic pulp, and can contain organic and inorganic fillers, sizing agents, retention agents, and other auxiliary agents. Retention agents are discussed in Pulp and Paper Dictionary, J. Lavigne, 2nd ed., Pulp and Paper Research Institute of Canada, Point Claire, Canada. In the formation of the pulp layer, a cellulosic pulp is added to a papermaking machine. The pulp can be included with a variety of other organic and inorganic additives, other fiber materials, and other additive materials. Pulps typically include pulps derived from cellulosic sources including wood pulp, cotton pulp, linder pulp, recycled waste paper, and other sources. Organic and inorganic fibers can be used along with synthetic pulps and others. Paper stocks are commonly characterized by thinness, smoothness, lack of permeability, and the ability to accept paper-coating materials. Inorganic fillers that can be used include calcium carbonate, clay materials, silica, diatomaceous earth, talc, aluminum salts, barium salts, titanium dioxide pigments, organic pigments, and others. The color and translucent character of the base layer can be modified using titanium dioxide pigments, calcium carbonate fillers, in relatively small particle size. The paper can include within the paper a layer; a variety of water-soluble resins, or such resins can be used as paper coatings on the formed sheets. The paper stock can also contain coatings derived from solutions or suspensions of materials in aqueous solutions or solvent systems. Aluminum salts and alumina, silicates and silica can be used in such coatings. Such coatings can be formed on the paper stock and can actually include aqueous dispersions of resins or latices as binders for the inorganic materials. Water soluble lattices that can be used include starchy materials, cationic starchy materials, PVOH, gelatin, algin salts, derivatized cellulose such as hydroxyethyl cellulose or carboxymethyl cellulose, polyacrylamid-type polymers, polystyrene sulfonate polymers, acrylic polymers, polyvinylpyrridine polymers, ethylene oxide and propylene oxide polymers, copolymers and terpolymers can be used, grafted polymers thereof, and other unknown resins. The final paper of the invention can contain one or more fine fiber layers, one or more organic or inorganic coating layers, combined with a paper base that can contain a cellulosic fiber combined with other natural or synthetic fibers, papermaking additives, sizing agents, pigments, or other papermaking chemicals.

Among the water-soluble resins to be used in the papers of the invention are starch, cationic starch, polyvinylalcohol, gelatin, sodium alginate, hydroxyethylcellulose, carboxymethylcellulose, polyacrylamide, polystyrene sulfonate, polyacrylate, polydimethyldiallylammonium chloride, polyvinylbenzyltrimethylammonium chloride, polyvinylpyridine, polyvinylpyrrolidone, polyethyleneoxide, hydrolysis product of starch-acrylonitrile graftpolymer, polyethyleneimine, polyalkylene-polyaminedicyandiamideammonium condensate, polyvinylpyridinium halide, poly-(meth)acrylalkyl quaternary salts, poly-(meth)acrylamidealkyl quaternary salts and the like. Among these, cationic starch, whose aqueous solution shows low viscosity, polyacrylamide, polydimethyldiallylammonium chloride, and polyvinylpyrrolidone are particularly desirable for this invention. Among the retention aid to be used in this invention are vegetable gum, cationic starches, potato starches, sodium aluminate, colloidal animal glue, acrylamide resin, aluminum sulfate, styrene-acrylic resin, polyethylene-imine, modified polyethylene-imine, polyethylene-imine quaternary salt, carboxylated polyacrylamide partially aminated polyacrylamide, acid addition compounds of partially aminomethylated polyacrylamide, acid addition compounds of partially methylolated polyacrylamide, epichlorohydrin resin, polyamide epichlorohydrin resin, formalin resin, modified polyacrylamide resin and the like.

The fine fibers comprise an ink accepting and maintaining layer or coating comprise a fine fiber containing layer(s) of the invention can be fiber and can have a diameter of about 0.01 to 5 micron, preferably 0.05 to 1 micron. The thickness of the typical fine fiber printable coating ranges from about 1 to 100 microns, preferably about 2 to 50 microns, with a pore size of about 10 to 500 nm, preferably about 25 to 400 nm, most preferably about 50 to 300 nm, with a basis weight ranging from about 1 E-5 to 10 E-3 grams-cm⁻², preferably about 1.05E-5 to 5.25E-3 gm-cm².

Polymer materials that can be used in the polymeric ink-accepting layers or coatings of the invention include both addition polymer and condensation polymer materials such as polyolefin, polyacetal, polyamide, polyester, cellulose ether and ester, polyalkylene sulfide, polyarylene oxide, polysulfone, modified polysulfone polymers and mixtures thereof. Preferred materials that fall within these generic classes include polyethylene, polypropylene, poly (vinylchloride), polymethylmethacrylate (and other acrylic resins), polystyrene, and copolymers thereof (including ABA type block copolymers), poly(vinylidene fluoride), poly(vinylidene chloride), polyvinylalcohol in various degrees of hydrolysis (87% to 99.5%) in crosslinked and non-crosslinked forms. Preferred addition polymers tend to be glassy (a Tg greater than room temperature). This is the case for polyvinylchloride and polymethylmethacrylate, polystyrene polymer compositions or alloys or low in crystallinity for polyvinylidene fluoride and polyvinylalcohol materials. One class of polyamide condensation polymers are nylon materials. The term “nylon” is a generic name for all long chain synthetic polyamides. Typically, nylon nomenclature includes a series of numbers such as in nylon-6,6 which indicates that the starting materials are a C₆ diamine and a C₆ diacid (the first digit indicating a C₆ diamine and the second digit indicating a C₆ dicarboxylic acid compound). Another nylon can be made by the polycondensation of epsilon caprolactam in the presence of a small amount of water. This reaction forms a nylon-6 (made from a cyclic lactam—also known as episilon-aminocaproic acid) that is a linear polyamide. Further, nylon copolymers are also contemplated. Copolymers can be made by combining various diamine compounds, various diacid compounds and various cyclic lactam structures in a reaction mixture and then forming the nylon with randomly positioned monomeric materials in a polyamide structure. For example, a nylon 6,6-6,10 material is a nylon manufactured from hexamethylene diamine and a C₆ and a C₁₀ blend of diacids. A nylon 6-6,6-6,10 is a nylon manufactured by copolymerization of epsilonaminocaproic acid, hexamethylene diamine and a blend of a C₆ and a C₁₀ diacid material.

Block copolymers are also useful in the ink-accepting coatings of this invention. With such copolymers the choice of solvent swelling agent is important. The selected solvent is such that both blocks were soluble in the solvent. One example is a ABA (styrene-EP-styrene) or AB (styrene-EP) polymer in methylene chloride solvent. If one component is not soluble in the solvent, it will form a gel. Examples of such block copolymers are Kraton® type of styrene-b-butadiene and styrene-b-hydrogenated butadiene(ethylene propylene), Pebax® type of e-caprolactam-b-ethylene oxide, Sympatex® polyester-b-ethylene oxide and polyurethanes of ethylene oxide and isocyanates.

Addition polymers like polyvinylidene fluoride, syndiotactic polystyrene, copolymer of vinylidene fluoride and hexafluoropropylene, polyvinyl alcohol, polyvinyl acetate, amorphous addition polymers, such as poly(acrylonitrile) and its copolymers with acrylic acid and methacrylates, polystyrene, poly(vinyl chloride) and its various copolymers, poly(methyl methacrylate) and its various copolymers, can be solution spun with relative ease because they are soluble at low pressures and temperatures. However, highly crystalline polymer like polyethylene and polypropylene require high temperature, high pressure solvent if they are to be solution spun. Therefore, solution spinning of the polyethylene and polypropylene is very difficult. Electrostatic solution spinning is one method of making fine fibers and microfiber.

We have also found a substantial advantage to forming polymeric compositions comprising two or more polymeric materials in polymer admixture, alloy format or in a crosslinked chemically bonded structure. We believe such polymer compositions improve physical properties by changing polymer attributes such as improving polymer chain flexibility or chain mobility, increasing overall molecular weight and providing reinforcement through the formation of networks of polymeric materials.

In one embodiment of this concept, two related polymer materials can be blended for beneficial properties. For example, a high molecular weight polyvinylchloride can be blended with a low molecular weight polyvinylchloride. Similarly, a high molecular weight nylon material can be blended with a low molecular weight nylon material. Further, differing species of a general polymeric genus can be blended. For example, a high molecular weight styrene material can be blended with a low molecular weight, high impact polystyrene. A Nylon-6 material can be blended with a nylon copolymer such as a Nylon-6; 6,6; 6,10 copolymer. Further, a polyvinylalcohol having a low degree of hydrolysis such as a 87% hydrolyzed polyvinylalcohol can be blended with a fully or superhydrolyzed polyvinylalcohol having a degree of hydrolysis between 98 and 99.9% and higher. All of these materials in admixture can be crosslinked using appropriate crosslinking mechanisms. Nylons can be crosslinked using crosslinking agents that are reactive with the nitrogen atom in the amide linkage. Polyvinylalcohol materials can be crosslinked using hydroxyl reactive materials such as monoaldehydes, such as formaldehyde, ureas, melamine-formaldehyde resin and its analogues, boric acids and other inorganic compounds. dialdehydes, diacids, urethanes, epoxies and other known crosslinking agents. Crosslinking technology is a well known and understood phenomenon in which a crosslinking reagent reacts and forms covalent bonds between polymer chains to substantially improve molecular weight, chemical resistance, overall strength and resistance to mechanical degradation.

Fluoropolymer materials can be used in the fine fiber layers of the invention. Fluoropolymer elastomers are preferred. The most commonly available Fluoropolymer elastomer is the Viton® (DuPont) elastomeric composition. The preferred use of the fluoropolymer elastomer is in the dual layer of fine fiber. Such dual layers can comprise a fabric substrate, a first layer of fluoropolymer elastomer fine fiber followed by a second layer of a second fine fiber composition.

Viton exhibits good resistance to most oils, chemicals, solvents, and halogenated hydrocarbons, and an excellent resistance to ozone, oxygen, and weathering. Also referred to as fluoroelastomers, fluorocarbon compounds are thermoset elastomers containing fluorine. Fluorocarbons make excellent general-purpose fibers thanks to their exceptional resistance to chemicals, oils, and temperature extremes (−15° F. to +400° F.). Specialty compounds can further extend the low temperature limit down to −22° F. for dynamic seals and −40° F. in static applications. Fluorocarbons typically have good temperature performance, and resistance to ozone and sunlight. Over the last five decades, this remarkable combination of properties has prompted the use of fluorocarbon seals in a variety of demanding sectors. The useful temperature range of the materials is about −10° F. to +400° F. in continuous service.

Suitable haloelastomers for use herein include any suitable halogen containing elastomer such as chloroelastomers, bromoelastomers, fluoroelastomers, or mixtures thereof. Fluoroelastomer examples include those described in detail in Lentz, U.S. Pat. No. 4,257,699, as well as those described in Eddy et al., U.S. Pat. No. 5,017,432 and Ferguson et al., U.S. Pat. No. 5,061,965. The disclosures of each of these patents are totally incorporated herein by reference. The original commercial fluorocarbon, Viton® A, is the general-purpose type and is still the most widely used. It is a copolymer of vinylidene fluoride (VF2) and hexafluoropropylene (HFP). Generally composed of 60-70% fluorine, Viton A compounds offer excellent resistance against many automotive and aviation fuels, as well as both aliphatic and aromatic hydrocarbon process fluids and chemicals. Viton A compounds are also resistant to engine lubricating oils, aqueous fluids, steam, and mineral acids. Viton B fluorocarbons are terpolymers combining tetrafluoroethylene (TFE) with VF2 and HFP. Depending on the exact formulation, the TFE partially replaces either the VF2 (which raises the fluorine level to approximately 68%) or the HFP (keeping the fluorine level steady at 66%). Viton B compounds offer better fluids resistance than the Viton A copolymers. Viton GF fluorocarbons are tetrapolymers composed of TFE, VF2, HFP, and small amounts of a cure site monomer (Csm). Presence of the cure site monomer allows peroxide curing of the compound, which is normally 70% fluorine. As the most fluid resistant of the FKM types, Viton GF compounds offer improved resistance to water, steam, and acids.

Viton GFLT fluorocarbons are similar to Viton GF, except that perfluoromethylvinyl ether (PMVE) is used in place of HFP. The “LT” in Viton GFLT stands for “low temperature.” The combination of VF2, PMVE, TFE, and a cure site monomer is designed to retain both the superior chemical resistance and high heat resistance of the G-series fluorocarbons. In addition, Viton GFLT compounds (typically 67% fluorine) offer the lowest swell and the best low temperature properties of the types discussed here. Viton GFLT can seal in a static situation down to approximately −40° F. A brittle point of −50° F. can be achieved through careful compounding.

As described therein, the next generation of these fluoroelastomers include copolymers and terpolymers of vinylidenefluoride, hexafluoropropylene and tetrafluoroethylene, which are known commercially under various designations as VITON® A, VITON® E, VITON® E60C, VITON® E45, VITON® E430, VITON® B910, VITON® GH, VITON® B50, VITON® E45, and VITON® GF. The VITON® designation is a Trademark of E.I. DuPont de Nemours, Inc. Two preferred known fluoroelastomers are (1) a class of copolymers of vinylidenefluoride, hexafluoropropylene and tetrafluoroethylene, (such as a copolymer of vinylidenefluoride and hexafluoropropylene) known commercially as VITON® A, (2) a class of terpolymers of vinylidenefluoride, hexafluoropropylene and tetrafluoroethylene known commercially as VITON® B, and (3) a class of tetrapolymers of vinylidenefluoride, hexafluoropropylene, tetrafluoroethylene and a cure site monomer. The cure site monomer can be those available from DuPont such as 4-bromoperfluorobutene-1,1,1-dihydro-4-bromoperfluorobutene-1,3-bromoperfluoropropene-1,1,1-dihydro-3-bromoperfluoropropene-1, or any other suitable, known, commercially available cure site monomer. In another preferred embodiment, the fluoroelastomer is a tetrapolymer having a relatively low quantity of vinylidenefluoride. An example is VITON® GF, available from E.I. DuPont de Nemours, Inc. The VITON® GF has 35 weight percent of vinylidenefluoride, 34 weight percent of hexafluoropropylene and 29 weight percent of tetrafluoroethylene with 2 weight percent cure site monomer. Typically, these fluoroelastomers are cured with a nucleophilic addition curing system, such as a bisphenol crosslinking agent with an organophosphonium salt accelerator as described in further detail in the above-referenced Lentz patent and in U.S. Pat. No. 5,017,432. The fluoroelastomer is generally cured with bisphenol phosphonium salt, or a conventional aliphatic peroxide curing agent. Some of the aforementioned haloelastomers and others that can be selected include VITON® E45, AFLAS®, FLUOREL® I, FLUOREL® II, TECHNOFLON® and the like commercially-available haloelastomers. Similar polymers are available from 3M as Dynion products.

Unless otherwise indicated, the discussion herein of the hydrocarbon chains refers to the unreacted form. Each of the hydrocarbon chains (excluding any carbon atoms which may be in the functional groups) has, for example, from about 6 to about 14 carbon atoms, and preferably from about 8 to about 12 carbon atoms. The hydrocarbon chains are preferably saturated such as alkanes like hexane, heptane, decane, and the like. Each hydrocarbon chain may have one, two, or more functional groups, a functional group coupled to, for instance, an end carbon atom, to facilitate covalent bonding of the hydrocarbon chain to the backbone of the haloelastomer. It is preferred that each hydrocarbon chain has only one functional end group. The functional group or groups may be for instance —OH, —NH₂, —NRH, —SH, —NHCO₂, where R is hydrogen or a lower alkyl having, for example, from about 1 to about 4 carbon atoms. The hydrocarbon chains bonded to the haloelastomer can be similar or identical to the carrier fluids conventionally employed in liquid developers. About 85 to about 100 percent of the hydrocarbon chains are saturated, and particularly preferred, from about 95 to about 100 percent. The outer layer preferably has a thickness ranging, for example, from about 0.1 to about 10 mils, preferably from about 0.2 to about 5 mils, and more preferably from about 1 to about 3 mils.

We have found that additive materials can significantly improve the properties of the polymer materials in the form of a fine fiber. Additive materials can improve the surface character of the paper and can improve the resistance of the coating and paper to the effects of heat, humidity, impact, mechanical stress and other negative environmental effect. We believe that the fine fibers of the invention in the form of a microfiber are improved by the presence of the additives due to the formation of a protective layer coating, ablative surface or penetrate the surface to some depth to improve the nature of the polymeric material. These materials are manufactured in compositions that have a portion of the molecule that tends to be compatible with the polymer material affording typically a physical bond or association with the polymer while the strongly hydrophilic group, as a result of the association of the additive with the polymer, forms a protective surface layer that resides on the surface or becomes alloyed with or mixed with the polymer surface layers. For 0.2-micron fiber with 10% additive level, the surface thickness is calculated to be around 50 Å, if the additive has migrated toward the surface. Migration is believed to occur due to the incompatible nature of the oleophobic or hydrophobic groups in the bulk material. A 50 Å thickness appears to be reasonable thickness for protective coating. For 0.05-micron diameter fiber, 50 Å thickness corresponds to 20% mass. For 2 microns thickness fiber, 50 Å thickness corresponds to 2% mass. Preferably the additive materials are used at an amount of about 2 to 25 wt. %. Cationic, anionic nonionic and amphoteric surfactant materials can be used.

The cationic groups that are usable in the agents employed in this invention may include an amine or a quaternary ammonium cationic group which can be oxygen-free (e.g., —NH₂) or oxygen-containing (e.g., amine oxides). Such amine and quaternary ammonium cationic hydrophilic groups can have formulas such as —NH₂, —(NH₃)X, —(NH(R²)₂)X, —(NH(R²)₃)X, or —N(R₂)₂→O, where x is an anionic counterion such as halide, hydroxide, sulfate, bisulfate, or carboxylate, R² is H or C₁₋₁₈ alkyl group, and each R² can be the same as or different from other R² groups. Preferably, R² is H or a C₁₋₁₆ alkyl group and X is halide, hydroxide, or bisulfate.

The anionic groups that are usable in the agents employed in this invention include groups which by ionization can become radicals of anions. The anionic groups may have formulas such as —COOM, —SO₃M, —OSO₃M, —PO₃HM, —OPO₃M₂, or —OPO₃HM, where M is H, a metal ion, (NR¹₄)⁺, or (SR¹₄)⁺, where each R¹ is independently H or substituted or unsubstituted C₁-C₆ alkyl. Preferably M is Na⁺ or K⁺. The preferred anionic groups of the fluoro-organo wetting agents used in this invention have the formula —COOM or —SO₃M. Included within the group of anionic fluoro-organic wetting agents are anionic polymeric materials typically manufactured from ethylenically unsaturated carboxylic mono- and diacid monomers. The amphoteric groups which are usable in the fluoro-organic wetting agent employed in this invention include groups which contain at least one cationic group as defined above and at least one anionic group as defined above.

The nonionic groups which are usable in the agents employed in this invention include groups which are hydrophilic but which under pH conditions of normal agronomic use are not ionized. The nonionic groups may have formulas such as —O(CH₂CH₂)xOH where x is greater than 1, —SO₂NH₂, —SO₂NHCH₂CH₂OH, —SO₂N(CH₂CH₂H)₂, —CONH₂, —CONHCH₂CH₂OH, or —CON(CH₂CH₂OH)₂.

Further, nonionic hydrocarbon surfactants including lower alcohol ethoxylates, fatty acid ethoxylates, nonylphenol ethoxylates, etc. can also be used as additive materials for the invention. Examples of these materials include Triton X-100 and Triton N-101.

Useful materials for use as an additive material in the compositions of the invention are tertiary butylphenol oligomers. Such materials tend to be relatively low molecular weight aromatic phenolic resins. Such resins are phenolic polymers prepared by enzymatic oxidative coupling. The absence of methylene bridges result in unique chemical and physical stability. These phenolic resins can be crosslinked with various amines and epoxies and are compatible with a variety of polymer materials. These materials are generally exemplified by the following structural formulas which are characterized by phenolic materials in a repeating motif in the absence of methylene bridge groups having phenolic and aromatic groups.

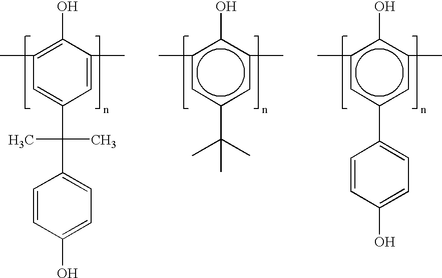

wherein n is 2 to 20. Examples of these phenolic materials include Enzo-BPA, Enzo-BPA/phenol, Enzo-TBP, Enzo—COP and other related phenolics were obtained from Enzymol International Inc., Columbus, Ohio.

Electrospinning small diameter fiber less than 10 micron is obtained using an electrostatic force from a strong electric field acting as a pulling force to stretch a polymer jet into a very fine filament. A polymer melt can be used in the electrospinning process, however, fibers smaller than 1 micron are best made from polymer solution. As the polymer mass is drawn down to smaller diameter, solvent evaporates and contributes to the reduction of fiber size. Choice of solvent is critical for several reasons. If solvent dries too quickly, then fibers tend to be flat and large in diameter. If the solvent dries too slowly, solvent will redissolve the formed fibers. Therefore matching drying rate and fiber formation is critical. At high production rates, large quantities of exhaust air flow helps to prevent a flammable atmosphere, and to reduce the risk of fire. A solvent that is not combustible is helpful. In a production environment the processing equipment will require occasional cleaning. Safe low toxicity solvents minimize worker exposure to hazardous chemicals.

The electrostatic spinning process can form the microfiber or fine fiber of the coating. An electro spinning apparatus includes a reservoir in which the fine fiber forming polymer solution is contained, a pump and an emitting device to which the polymeric solution is pumped. The emitter obtains polymer solution from the reservoir and the electrostatic field as discussed below accelerates a droplet of the solution toward the collecting media. Facing the emitter, but spaced apart therefrom, is a substantially planar grid upon which the collecting media substrate or combined substrate is positioned. Air can be drawn through the grid. The collecting media is positioned proximate the grid. A high voltage electrostatic potential is maintained between emitter and grid with the collection substrate positioned there between by means of a suitable electrostatic voltage source and connections and that connect respectively to the grid and emitter.

In use, the polymer solution is pumped to the emitter. The electrostatic potential between grid and the emitter imparts a charge to the material that cause liquid to be emitted there from as thin fibers which are drawn toward grid where they arrive and are collected on substrate in sufficient quantity to form an ink accepting coating in a robust, mechanically stable unitary layer or layers. In the case of the polymer in solution, solvent is evaporated off the fibers during their flight to the grid; therefore, the fibers arrive at the collection substrate. The fine fibers bond to the substrate fibers first encountered at the grid. Electrostatic field strength is selected to ensure that the polymer material as it is accelerated from the emitter to the collecting substrate media, the acceleration is sufficient to render the material into a very thin microfiber or fine fiber structure. Increasing or slowing the advance rate of the collecting media can deposit more or less emitted fibers on the forming media, thereby allowing control of the thickness of each layer deposited thereon. The sheet-like collection substrate is formed with fine fiber. The sheet-like substrate is then directed to a separation station wherein the fine fiber layer or layers is removed from the substrate, if needed, in a continuous operation. If further layers are to be formed the continuous length of sheet-like substrate is directed to a fine fiber spinning station wherein the spinning device forms additional fine fiber layers and lays the fine fiber the coating. After the fine fiber layer(s) are formed on the sheet-like substrate, the fine fiber layer and substrate are directed to a heat treatment and pressure such as a calendaring station for appropriate processing to form the layer(s) into a final layer with a compressed thickness and basis weight. The sheet-like substrate and fine fiber layer(s) is then tested for QC in an appropriate station such as an efficiency monitor. After processing, the media of the invention, the media can comprise a single layer or multilayers of the fine fiber formed into a continuous sheet-like media structure. After processing is complete and the media is in its final thickness, a single layer of the media structure can comprise a final depth of about 0.1 to about 100 microns, preferably about 1 to about 50 microns, most preferably about 1 to about 15 microns. In multilayer structures, the overall final thickness can range from about 0.1 to about 100 microns with each individual layer having a thickness of about 0.1 to about 100 microns, preferably about 0.3 to about 50 microns.

### Experimental

The properties of fine fiber to maintain alpha numeric and image quality was first noted on fine fiber layers formed on filtration substrates. While the invention is directed to a paper material filter media constitute a difficult test vehicle due to the high permeability of the layers tend to result in poor character and image formation. The highly porous, permeable and rough nature of this filtration media cause rapid and general ink bleeding when low viscosity liquid inks are used on the media. We applied fine fiber to a Reemay 2214 polyester substrate in the following amounts:

TABLE 1

| | | Number of | |
|---|---|---|---|
| Example | Fiber Size | Layers | Morphology |
| 1 | 0.2 micron | 25 | structure about 30 |
| | | | micron thick |
| 2 | 0.2 micron | 20 | structure about 15 |
| | | | microns thick |
| 3 | 0.2 micron | 5 | structure about 4.4 |
| | | | microns thick |
| 4 | 0.1 micron | 15 | |
| 5 | 0.1 micron | 5 | |

Once formed, we placed alpha numeric characters on to the fine fiber layer noticing that, unlike uncoated stock, the fine fiber layer maintained a high quality, sharp, alpha numeric character. When observed under an optical stereo microscope, no discernible bleeding, (i.e., transverse ink flow or wicking) was found in the fine fiber layer. This resistance to bleeding was visually compared to the performance of a commercially available high gloss paper and the performance appeared to be substantially identical.

We have measured the porosity of the fine fiber layer which is set forth in the following data table. Using xerographic grade of paper (Boise Cascade X-9000), a fine fiber layer or layers were placed on the surface of the paper. Samples were made from production polymer (fiber diameter ˜0.25 micron).

TABLE 2

| | Mean Pore Size |
|---|---|
| Example | (microns) |
| 6 | 1.92 |
| 7 | 1.49 |
| 8 | 1.46 |
| 9 | 1.35 |
| 10 | 0.93 |
| 11 | 0.68 |
| 12 | 0.98 |
| 13 | 0.78 |
| 14 | 0.51 |

Graphic material was printed on the papers coated with the fiber of the invention, uncoated test papers and on premium photo grade papers using an ink jet printer to print test pages. In all cases the papers accepted the ink. The ink dried quickly on the untreated paper. We noticed that the ink appeared wet on the premium picture papers. On the papers with the fiber of the invention we found that that the more fiber we put down, the wetter the ink appeared after printing, but none of our fiber covered papers appeared as wet as the premium picture papers. From reviews under an optical microscope, it appeared that the ink wicked through the fine fiber interior structure down to the paper underneath, where it had the opportunity to bleed sideways through the paper fibers.

We believe these data demonstrate the acceptance and holding properties of microporous surface structure of the fine fiber layers. The fine fiber material, by itself, has an important ink holding characteristic. Such characteristics can be improved using further coating or layers in conjunction with the fine fiber layer. The preferred orientation of these layers is to form the fine fiber structure on a coated paper. As ink contacts the fine fiber and is conducted through the microporous structure of the fine fiber layer, the ink come in contact with the microporous structure of the fine fiber layer and penetrates the microporous structure to come in contact with the paper layers formed below the fine fiber. The presence of a coating layer at the base of the fine fiber layer can further aid in improving the ink holding characteristics of the layers. One important differentiation between the prior art structures and the structures of the invention relates to the differences between fine fiber containing filter media and the fine fiber coated paper stock of the invention. In the formation of filter media, when used in a filtration process, the fine fiber containing media can easily pass a fluid such as air or water with minimal pressure drop. As such, minimum flow rates for such fluids are 2 fpm, preferably greater than 4 fpm. Commonly, the fine fiber coated paper materials of the invention when placed in such filtration locations, while they remain intact under conditions of gas or liquid flow, have substantially no useful permeability, substantially no filtration porosity, and have a very high pressure drop across the layer. This remains true in light of the fact that coated papers pass little or no fluid unless the paper fails mechanically.

The above description, examples, and experimental data provide a basis for understanding the operation of the invention. However, since the invention can obtain a variety of embodiments without departing from the spirit and scope of the invention, the invention resides in the claims hereinafter appended.

We claim:

1. A printable structure capable of accepting and maintaining an alpha numeric character or graphic image, said structure comprising:
(a) a continuous substrate; and
(b) at least one layer comprising fine fiber, the fine fiber having a fiber size that ranges from about 0.01 to less than 2 microns and the layer comprises a thickness of less than 200 microns;
wherein the fine fiber layer has a microporous structure characterized by a pore size that ranges from about 10 nM to 3 microns.

2. The printable structure of claim 1 wherein the fine fiber has a microporous structure characterized by a pore size that ranges from about 10 to 500 nM.

3. The printable structure of claim 1 wherein the fine fiber has a microporous structure characterized by a pore size that ranges from about 50 to 250 nM.

4. The printable structure of claim 1 wherein the substrate comprises a paper product.

5. The printable structure of claim 4 wherein the fine fiber has a diameter of about 0.1 to about 0.5 micron.

6. The printable structure of claim 3 wherein the fine fiber has a diameter of about 0.1 to about 0.3 micron.

7. The printable structure of claim 1 wherein the nanofiber comprises 1 to 50 layers of fine fiber, each layer having a thickness of about 0.5 to 5 microns.

8. The printable structure of claim 1 wherein the fine fiber comprises 2 to 20 layers of fine fiber, each layer having a thickness of about 0.5 to 5 microns.

9. The printable structure of claim 4 wherein the substrate comprises a paper base, a first coating on the paper and a fine fiber layer on the first coating.

10. The printable structure of claim 9 wherein the paper coating comprises an inorganic material, an organic material or mixtures thereof.

11. The printable structure of claim 1 wherein the fine fiber comprises an addition polymer.

12. The printable structure of claim 11 wherein the addition polymer additionally comprises an additive.

13. The printable structure of claim 12 wherein the additive comprises a hydrophobic coating on the fine fiber surface.

14. The printable structure of claim 13 wherein the hydrophobic coating has a thickness of less than 100 Å.

15. The printable structure of claim 11 wherein the addition polymer comprises a polyvinyl halide polymer, a polyvinylidene halide polymer or mixtures thereof.

16. The printable structure of claim 11 wherein the addition polymer comprises a polyvinyl alcohol.

17. The printable structure of claim 16 wherein the polyvinyl alcohol is crosslinked with about 1 to 40 wt. % of a crosslinking agent.

18. The printable structure of claim 17 wherein the crosslinking agent comprises a polymer comprising repeating units of acrylic acid, the polymer having a molecular weight of about 1000 to 5000.

19. The printable structure of claim 17 wherein the crosslinking agent comprises a melamine-formaldehyde resin having a molecular weight of about 1000 to 3000.

20. The printable structure of claim 15 wherein the polyvinyl halide is crosslinked.

21. The printable structure of claim 1 wherein the fine fiber comprises condensation polymer.

22. The printable structure of claim 21 wherein the condensation polymer additionally comprises an additive.

23. The printable structure of claim 22 wherein the additive comprises a hydrophobic coating on the fine fiber surface.

24. The printable structure of claim 23 wherein the hydrophobic coating has a thickness of less than 100 Å.

25. The printable structure of claim 21 wherein the condensation polymer comprises a polyester.

26. The printable structure of claim 21 wherein the condensation polymer comprises a nylon polymer.

27. The printable structure of claim 26 wherein the nylon polymer is combined with a second nylon polymer, the second nylon polymer differing in molecular weight or monomer composition.

28. The printable structure of claim 22 wherein the additive comprises a fluoropolymer.

29. The printable structure of claim 21 wherein the condensation polymer comprises a polyurethane polymer.

30. The printable structure of claim 21 wherein the condensation polymer comprises an aromatic polyamide.

31. The printable structure of claim 21 wherein the condensation polymer comprises a polyarylate.

32. The printable structure of claim 26 wherein the nylon copolymer comprises repeating units derived from a cyclic lactam, a C₆₋₁₀ diamine monomer and a C₆₋₁₀ diacid monomer.

33. The printable structure of claim 12 wherein the fine fiber comprises about 2 to 25 wt % of an additive comprising a resinous material having a molecular weight of about 500 to 3000 and an aromatic character wherein the additive is miscible in the polymer.

34. The printable structure of claim 22 wherein the fine fiber comprises about 2 to 25 wt % of an additive comprising a resinous material having a molecular weight of about 500 to 3000 and an aromatic character wherein the additive is miscible in the polymer.

35. A method of making a printable structure having a printable layer wherein the layer comprises a distribution of fine fiber on a substrate, the layer comprising a fiber having a diameter of about 0.01 to 0.5 micron, the layer having a thickness of less than about 100 Å, the method comprises forming a solution comprising a lower alcohol, water or mixtures thereof and about 3 to about 30 wt % of a polymer composition exposing the polymer solution to an electric field of a potential greater than about 10×10³ volts causing the solution to form accelerated strands of solution which upon evaporation of the solvent forms a fine fiber, collecting the fine fiber on the substrate and exposing the fine fiber and substrate to a heat treatment, the heat treatment raising the temperature of the fine fiber to a temperature less than the melting point of the polymer.

36. The method of claim 32 wherein the solvent comprises a combined aqueous alcoholic solvent.

37. The method of claim 32 wherein the solvent comprises a mixture of a major proportion of water and about 10 to 90 wt % of an alcohol selected from the group consisting of methanol, ethanol, isopropanol, n-propanol, butanol or mixtures thereof.

38. The printable structure of claim 11 wherein the addition polymer comprises an acrylic polymer having a fiber size of about 0.01 to 0.5 micron.

39. The printable structure of claim 1 wherein the fine fiber comprises the reaction product of a polymer resin and a cross linking agent, the fiber having a fiber size of about 0.01 to 0.5 micron.

40. The printable structure of claim 39 wherein the polymer resin comprises a blend of two polymer resins and has a diameter of 0.01 to 0.2 micron.

41. The printable structure of claim 39 wherein the crosslinking agent comprises urea formaldehyde, melamine formaldehyde, phenol formaldehyde, or mixtures thereof.

42. The printable structure of claim 39 wherein the crosslinking agent comprises a dialdehyde, trialdehyde, tetraaldehyde, a diacid, a urethane reactant, epoxy reactant, or mixtures thereof.

43. The printable structure of claim 1 wherein a fine fiber comprising a polyvinyl chloride having a fiber size of about 0.01 to 0.5 micron.

44. The printable structure of claim 43 wherein the polyvinyl chloride comprises a blend of two polyvinyl chloride polymers and the fine fiber has a diameter of 0.01 to 0.5 micron.

45. The printable structure of claim 44 wherein the fine fiber has a diameter of 0.01 to 0.2 micron.
